(19) United States
(12) Patent Application Publication
(10) Pub. No.: US 2005/0018683 A1
(43) Pub. Date: Jan. 27, 2005

(54) IP address storage technique for longest prefix match

(76) Inventors: Yigiang Q. Zhao, Nepean (CA); Xuehong Sun, Ottawa (CA)

Correspondence Address: CASSAN MACLEAN, 80 ABERDEEN STREET, SUITE 401, OTTAWA, ON, K1S 5R5, CA

(21) Appl. No.: 10/624,167

(22) Filed: Jul. 21, 2003

(51) Int. Cl. H04L 12/28

(52) U.S. Cl. 370/393; 370/401

(57) ABSTRACT

Methods and devices for storing binary IP addresses in memory. The longest prefix match problem is converted into a range search problem and the IP addresses corresponding to the different ranges are stored in a tree data structure. The nodes of the tree data structure are created from the bottom leaves up to the root node. The IP addresses are sorted by binary number order and grouped according to the number of common leading or trailing bits per group. For each group, the common leading and/or trailing bits are then removed and the number of bits removed are stored, along with the stripped IP addresses in that group, in a node in the tree data structure.

### FIELD OF THE INVENTION

The present invention generally relates to forwarding of data packets. More specifically, the present invention relates to but is not limited to methods and devices for the storage of IP (Internet Protocol) addresses for use in said routing of data packets. The present invention also applies to any other range search applications.

### BACKGROUND TO THE INVENTION

The recent boom in telecommunications has led to an increased reliance on Internet-based communications and an attendant demand for faster and more reliable forwarding of data. As is well-known in the field of networking and telecommunications, packet based network communications rely on matching a packet's destination address with at least one port for the packet's next hop towards its destination. This process, while seemingly straightforward, may involve searching hundreds of thousands, if not millions of IP addresses for even a partial match with the packet's IP address. Clearly, for fast forwarding of data through the Internet, this searching process must be efficient, reliable, and, ideally, cost-effective.

Numerous types of approaches and methods have been tried and implemented to alleviate the above problem. The fast pace of technological progress has, instead of alleviating the problem, exacerbated it. Current optical transmissions systems are now able to transmit data at tens of gigabits per second rates per fiber channel. The bottleneck in data transmission is no longer the actual transmission rate but is, in fact, the processing required to properly forward the data to its destination. To illustrate the speed at which such processing should be accomplished to keep pace with the transmission speeds, in order to achieve 40 gigabits/second (OC768) wire speed, a router needs to look up packets at a rate of 125 million packets/second. This, together with other packet processing, amounts to less than 8 ns per packet lookup. Single chip accesses to current memory chips takes anywhere from 1-5 ns using static RAM (SRAM) to about 10 ns for dynamic RAM (DRAM). For off-chip memory (i.e. the addresses are stored on a chip other than the chip performing the lookup), it takes anywhere from 10-20 ns (for SRAM) to 60-100 ns (for DRAM) for one access. Very often, one address lookup requires multiple memory accesses.

The above figures clearly illustrate that on-chip designs are more advantageous in terms of access times and allow the packet processing to keep pace with the ever increasing transmission speeds. However, one drawback of on-chip designs is the limitation on memory sizes for such designs. This limitation severely restricts the number of IP addresses that may be stored on-chip for the lookup process. For DRAM implementations, a maximum macro capacity size is 72.95 MB/31.80 mm2 with an access time of 9 ns while an SRAM implementation provides a maximum of 1 MB with an access time of 1.25 ns.

One solution which is currently being used is the TCAM or Ternary Content Addressable Memory. This technology, while providing acceptable performance, is roughly eight times more expensive than SRAM and also consumes about six times more power than SRAM. Such a solution, while workable, is expensive in terms of both dollar amounts and power consumption.

From the above, it can be seen that there is a need for methods which will minimize the memory storage requirement for an IP address forwarding table. Such a solution will allow greater use of traditional, less expensive and less power hungry technologies. It is therefore an object of the present invention to mitigate if not overcome the shortcomings of the prior art and to provide such a solution to allow the storage of more IP addresses in limited memory storage.

### SUMMARY OF THE INVENTION

The present invention provides methods and devices for storing binary IP addresses in memory. The longest prefix match problem is converted into a range search problem and the IP addresses corresponding to the different ranges are stored in a tree data structure. The nodes of the tree data structure are created from the bottom leaves up to the root node. The IP addresses are sorted by binary number order and grouped according to the number of common leading or trailing bits per group. For each group, the common leading and/or trailing bits are then removed and the number of bits removed are stored, along with the stripped IP addresses in that group, in a node in the tree data structure.

In a first aspect, the present invention provides a method for storing a plurality of binary numbers such that said binary numbers can be searched for match between a candidate binary number and one of said plurality of binary numbers, the method comprising:

a) sorting said plurality of binary numbers in order of numerical value;

b) grouping said plurality of binary numbers into subgroups, each binary number in a subgroup having at least one leading bit in common with other binary numbers in said subgroup;

c) for each of said subgroups, determining a number x of leading bits common to members of said subgroup;

d) for each subgroup, recording said number x of leading bits;

f) for each subgroup, creating stripped binary numbers by removing x leading bits from members of said subgroup; and

g) storing each of said stripped binary numbers for each subgroup in a node data structure in a tree data structure, said node also containing information regarding said common leading bits for said subgroup.

In a second aspect, the present invention provides a method of storing IP binary addresses in a tree data structure for use in a range search, the method comprising:

a) sorting a group of IP binary addresses in order of numerical value;

b) determining a number of sequential bits common to said group of IP binary addresses, said sequential bits being chosen from a group comprising:
leading bits
trailing bits.

c) removing said sequential bits common to said group of IP binary addresses from said IP binary addresses; and

d) storing said group in a node in said tree data structure.

### BRIEF DESCRIPTION OF THE DRAWINGS

A better understanding of the invention will be obtained by considering the detailed description below, with reference to the following drawings in which:

FIG. 1 illustrates an ordered set of endpoints showing the arrangement of the endpoints from Table 1 after being sorted;

FIG. 2 is a schematic tree data structure derived from the ordered set of endpoints in FIG. 1;

FIG. 3 is a diagram illustrating the different fields in a node data structure which may be used to create the tree data structure in FIG. 2;

FIG. 4 is a diagram illustrating the tree data structure of FIG. 2 as stored in memory using the node data structure of FIG. 3;

FIG. 5 is a flowchart illustrating the different steps in a generic process used for compressing and storing IP addresses in a node data structure;

FIG. 6 is a reference block diagram of a hardware setup which may practice the invention.

### DETAILED DESCRIPTION

As noted above, the challenge of matching one IP (Internet Protocol) address to a prefix is daunting. This problem, known as the longest prefix match problem (i.e. finding the largest number of matching bits between one IP address and a database of IP prefixes) may be simplified by converting the problem into a range search conundrum. Simply put, the IP prefixes in the database to be searched may be sorted by order of magnitude (i.e. largest first or largest last). Any IP addresses which seeks a match with the database will only need to determine where in the sorted addresses it needs to be slotted. The longest prefix match would be the smaller of the addresses on either side of the address being searched. As an example, if the address on either side of 110111 are 110110 (smaller in value) and 111001, then the longest prefix match is 110110.

To implement the above idea, a prefix P is defined as representing addresses in a range. When an address is expressed as an integer, the prefix P can be represented as a set of consecutive integers, expressed as [b, e) where b and e are integers and [b,e)={x:b≦x<e,x is an integer}. [b,e) is defined as the range of prefix P with b and e being defined as the left and right end points (or merely the end points) respectively, of prefix P. As an example, in the space of IP addresses with a length of 6 bits, the prefix 001* represents the addresses between 001000 and 001111 inclusive. In decimal form, this means that the addresses between 8 and 15 inclusive. Thus, the range is given by [8, 16) with 8 and 16 as the end points of the range.

For any two prefixes, their ranges can contain one another or are disjoint. The ranges of two prefixes cannot overlap one another as this would mean that the overlap contains addresses for which there are conflicting routing instructions. At most, the ranges of two prefixes may have one end point in common. Such an occurrence means that the two ranges can be merged into a single range if they happen to map to the same port. As an example, if prefix 001* has end points 8 and 16, and prefix 01* has end points 16 and 32, they share end point 16. If these two consecutive ranges share the same port then the shared end point 16 can be eliminated.

To map addresses to ports using the end points of a range, a unique port can be assigned to each range according to the rule of longest prefix match. An end point can be used to represent the range to the right of that end point (or the range of values greater or equal in value to the end point) and the port assigned to that range can be mapped to that end point. As an example, if a and b are successive end points, then if port A is assigned to end point a any address that is in [a, b) gets mapped to A.

To convert a sorted forwarding table into (end point, port) pairs, the logic in the following code may be used where “max” is the maximum integer (endpoint) in the address space, “def” is the default port for the address space, “M” is the variable for the endpoint and “N” is the variable for the port.

```
N=def;
M=max;
push N;
push M;
For each prefix P=[b, e) with port p
in the sorted forwarding table {
  pop M;
  If (b<M) {
  assign p to b;
  push M; (push back M.)
  push p;
  push e;
} else if (b=M) {
  assign p to b;
  while (b=M) {
    pop N;
    pop M;
  }
  push M; (M>b so push back.)
  push p;
  push e;
} else if (b>M) {
  oldM=M;
  while (b>M) {
    pop N;
    if (oldM not = M) {
    (assign oldM'port to M.)
      pop M;
      pop N; (get the next port.)
      assign port N to oldM;
      push N;
      push M; (push back N, M.)
    }
    oldM=M;
    pop M;
  }
  while (b=M) {
    pop N;
    pop M;
  }
  push M; (M>b so push back.)
  push p;
  push e;
}
```

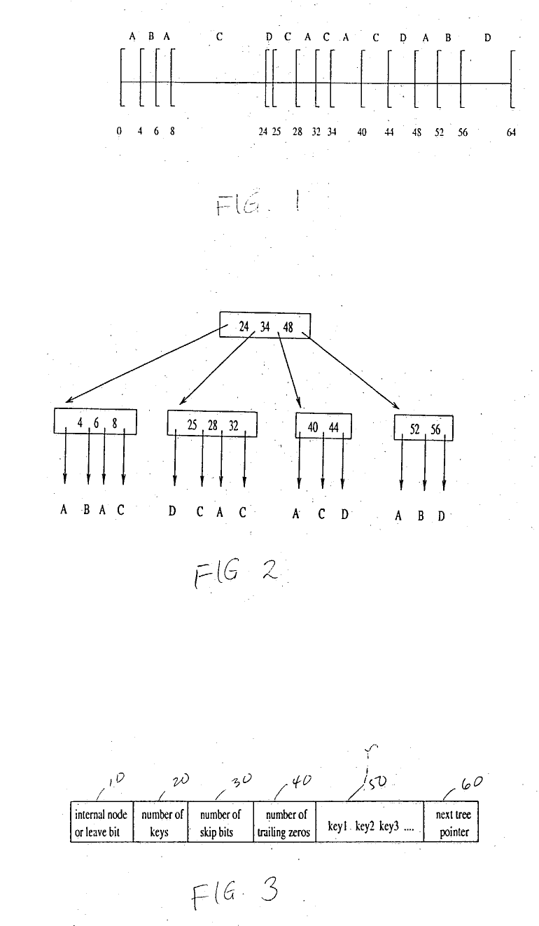

Please note that the above pseudocode does not perform the possible merging of end points mentioned above. This can be accomplished by using a variable to record the port assigned to the previous end point. Whenever there is a port assignment to an end point, the port to be assigned is checked against the port identifier stored into variable. If they are equal, the end point will be eliminated. If they are not, then the port is assigned normally. As an example, Table 1 is a small forwarding table with prefixes assigned to ports where the address length is 6 bits. After the table is processed using the pseudocode above, FIG. 1 emerges. In FIG. 1, the overlapping end points have been merged, reducing the total number of end points from 15 to 17.

TABLE 1

| Prefix | Port |
|---|---|
| 0* | A |
| 00010 | B |
| 001* | C |
| 01* | C |
| 01000* | D |
| 0111* | A |
| 1* | B |
| 10* | C |
| 10001* | A |
| 1001* | A |
| 1011* | D |
| 11* | D |
| 110* | A |
| 1101* | B |

The set of endpoints from FIG. 1 is {0, 4, 6, 8, 16, 24, 25, 28, 32, 34, 36, 40, 44, 48, 52, 56, 64}. Usually, 0 and the maximum value 64 can be eliminated. With the above process, the IP address lookup problem is converted into the Predecessor finding problem in a priority queue. The Predecessor finding problem is defined as follows: given a set of sorted integers S and an integer I, find an integer e in S such that e is the biggest one which is less than or equal to I. One of the solutions is to use a tree structure to tackle the predecessor finding problem. FIG. 2 is an example of the tree structure created from FIG. 1. The search is started from the root, then proceeds through internal nodes until a leaf is reached. The leaf has a pointer which leads to the corresponding port information. For example, in order to lookup 39, the root is searched and it is found that 34 is the largest address which is less than or equal to 39. Following the pointer, the third node in the next stage is searched. It is found that 39 is less than all the stored values. This address points to port A.

To accommodate regular IP addresses such as those which follow IPv4 and/or IPv6 format, compression of these addresses is required. As is well-known, an IPv4 address is 32 bits long, while an IPv6 address is 128 bits long. Given a set of IP addresses in binary format, once these addresses are sorted by value, patterns regarding common leading and trailing bits emerge. As an example, 6 IPv4 binary addresses for end points are given as:
11000000111011000100000000000000
11000000111011010010000000000000
11000000111011010100000000000000
11000000111011010111001000000000
11000000111011010111001100000000
11000000111011010111010000000000

It can be seen that all six end point addresses have 15 common leading bits (110000001110110) and eight common trailing 0s. These leading and trailing bits common to these addresses may be removed to thereby compress the addresses. Clearly, the greater the number of common leading and/or trailing bits for a group of binary IP addresses (for end points or otherwise), the greater the compression possible for that group. The number of common leading bits is related to the number of IP addresses (or end points) in a group/forwarding table. Intuitively, the larger the number of end points, then there is a larger number of common leading bits since the endpoints space is fixed and the endpoints tend to cluster when the number of endpoints is large.

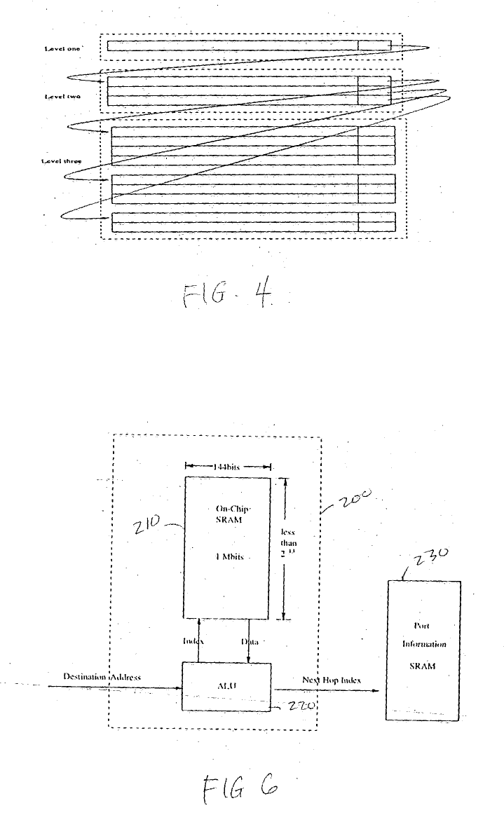

Since the six addresses above have common leading and trailing bits which will be stripped to compress them, the six addresses are best stored in a single node in the tree structure referred to above. The data structure used as a node in the tree is illustrated in FIG. 3.

As can be seen from FIG. 3, each field into the data structure contains specific data. The first field 10 is a one-bit field which indicates whether the node is an internal node or a leaf node. The second field 20 indicates how many end points are stored in this node. If the number of end points in any node does not exceed 16, then only four bits are needed for this field. The third field 30 indicates how many common leading bits were removed from the end points (IP address) while the fourth field 40 indicates how many trailing 0s were removed from the same end points. For IPv4 addresses, the third and fourth fields need, at most, 5 bits. For IPv6 addresses, these fields will require, at most, seven bits. The fifth field 50 actually contains compressed IP addresses after removal of the common leading bits and the trailing 0s. The last field 60 contains a pointer which indexes to the next level node in the tree structure. To support 500 k entries in a forwarding cable, this last field would require 20 bits. 500,000 entries in a forwarding table translates to (at most) approximately one million end points, each with its corresponding port information as each entry can produce at most two end points. For standard on-chip (i.e. internal) SRAM, these one million entries can be indexed using 20 bits.

To implement the above scheme in internal SRAM with 144 bits per row in the SRAM, and using only one row per node, each node will, for IPv4 addresses, have 109 bits for storage. For IPv6 addresses, 105 bits are available for storage. For IPv4 addresses, assuming each node is to occupy 144 bits in a row, the first four fields in the last field will occupy 1+4+5+5+20=35 bits. This will leave 109 bits from the original 144 bits available. Similarly, for IPv6 addresses, the fields not containing the addresses will consume 1+4+7+7+20=39 bits. After this is consumed for the original 144 bit space, this yields 105 bits in which to store actual compressed addresses.

It should be noted that while FIG. 3 in the description above presents the fields in a certain order, the fields may be used or implemented in any order. Also, it may be possible to remove the first field 10 (the internal or leaf node bit), thereby adding another two bits to the storage capacity for the addresses. Other variants of the above scheme are also possible. Bit widths other than 144 bits may be used for other types of memory. Similarly, capacities other than one million entries may be implemented with the attendant change in the pointer field width. As an example, a 22 bit pointer field (field 60 in FIG. 3) would be required to access two million entries in the forwarding table.

To store the nodes in a multi level hierarchal tree structure in memory, a scheme illustrated schematically in FIG. 4 may be used. The tree data structure in FIG. 4 consists of three hierarchal levels with each level containing at least one node. Each node in the lower levels (i.e. levels one and two) has a pointer which maps to another node in a higher level (i.e. levels two and three). It should be noted that the tree structure illustrated in FIG. 2 consists of only two levels which the second higher level having four nodes.

Further storage savings may be obtained by using a form of indexing on the nodes in a level. If the nodes in a given level are stored in order to consecutive rows, all the end points (IP addresses) in a node can share one pointer. To therefore find the correct node to access, one need only know what generated the need for that node. As an example, if you assume a node with sorted end points p₁, p₂, p₃, p₄, we would normally require five pointers—one pointer for each “gap” between end points (to be referenced for addresses smaller than the nearest end point to the right—i.e. for an address between end points p₃ and p₄, the pointer between p₃ and p₄ would be used), and one pointer each for addresses smaller than p₁ and for addresses greater than p₄. Using the indexing concept, only one pointer—the pointer that points to the node whose end points are small then p₁—would be needed. Since other nodes are stored in ordered consecutive rows, the nodes sought by search can be found by knowing the position of the destination address in the searched node. For example, if the search destination address is greater than or equal to p₃ but less than p₄, the relevant note can be found by adding three (for the fourth note) to the stored pointer. If a search destination address is less than p₁, then zero is added to the stored pointer to reference the very first node.

The above compression and storage scheme requires the determination of the number of common leading bits and common trailing zeros in a group of binary IP addresses sorted by value. To find the number of common leading bits for a group of sorted binary IP addresses, the largest valued and lowest valued binary IP addresses in the sorted group are compared and the number of common leading bits between these two IP addresses is the number of common leading bits for that group. To find a number of common trailing zeros for a group of sorted binary IP addresses, a recursive process may be used. The number of trailing zeros of the first binary IP address is first calculated and is saved as the candidate number of trailing zeros. The next binary IP address is then analyzed and its number of trailing zeros is determined. If the number of trailing zeros for the most recently analyzed binary IP address is smaller or lesser than the saved candidate number, then the new number is saved as the candidate. Otherwise, the next binary IP address is analyzed. The process is applied continuously until all the binary IP addresses have been analyzed. The final candidate number that has been saved at the end of the process is the number of common trailing zeros for the group.

It should be noted that while the above contemplates removing trailing zeroes from the group of binary IP addresses, other combinations of trailing bits that are mixed ones and zeroes with a regular pattern or an all ones pattern may also be removed. However, it has been found that dealing with combinations of ones and zeroes with an irregular has led to a more complicated tree data structure and more complex logic. The benefits of stripping more complex combinations is usually counteracted by the need for this more complicated data structure and more complex logic.

To actually implement the above scheme to arrive at a tree data structure, the tree data structure may be constructed from the leaves of the internal nodes. Determining how many end points (IP addresses) may be stored in a node can be done by a process of elimination. Using IPv4 addresses (32 bit IP addresses) as example, without compressing the IPv4 addresses, the 109 bits in the 144 bit node space can accommodate three end point addresses (3×32=96 bits). Thus, four end point addresses can be initially selected and the total number of bits occupied by these addresses (after compression) is calculated. If they total less than 109 bits, then another address is tried and the number of bits is, again, calculated. This process is continued until an address (compressed or not) can no longer be added to the 109 bits. Once 109 bits is exceeded, then the previous number of addresses is stored in the node. The process then continues for the next group of IP addresses to be stored in the node. While the above process is generic, a few variants which provide trade offs between speed and storage are possible. A few variants are explained below.

Variant One:

Let {e₁, e₂, e₃, . . . , eₙ} be the set of endpoints to be stored in a tree structure. Assume the first four endpoints {e₁, e₂, e₃,e₄} are stored in the first leaf node, then the endpoint e₅ will be stored in the next higher level node. Assume the next five endpoints {e₆, e₇, e₈,e_{9,} e₁₀} are stored in the second leaf node, then the endpoint e₁₁ will be stored in the next higher level node, and so on.

For this scheme, the endpoint in the next higher level node must be involved in the leaf nodes to calculate the compressed keys. Specifically, in the aforementioned example, e₁ and e₅ are involved to find the common leading bits of the first leaf node; {e₁, e₂, e₃,e_{4,}} are used to find the common trailing zeros of the first leaf node. e₅ and e₁₁ are involved in finding the common leading bits of the second leaf node; {e₆, e₇, e₈,e_{9,} e₁₀} are used to find the common trailing zeros of the second leaf node, and so on. The reason for involving the higher level endpoints in the calculation of compressed keys will be explained with reference to the 32 bit addresses below:
10000000 11001000 01000000 00000000
10000000 11001001 00100000 00000000
10000000 11101101 01000000 00000000
10000000 11101101 01110010 00000000
10000000 11101101 01110011 00000000
10000000 11101101 01110100 00000000
10000000 11101101 01111101 00000000
10000000 11101101 01111110 00000000
   .................................
10000110 11101111 00001101 10000000
   .................................
11010110 11101111 00001110 00000000
11010110 11101111 00100111 00000000
11011000 11101111 00101000 00000000
11011000 11101111 00110000 00000000
11011000 11101111 00110001 00000000
11011000 11110000 00000000 00000000
   .................................
11111000 11110000 00010000 11000000\\

In the 32 bit addresses given above, (the blank between bits is for convenience of reading) the first eight endpoints are stored in a leaf node. The next endpoint 10000110 11101111 00001101 10000000 will be stored in a higher level node. The next six endpoints following 10000110 11101111 00001101 10000000 will be stored in the next leaf node. 11111000 11110000 00010000 11000000 will be stored in a higher level node, and so on.

The common leading bits of the first leaf node is 10000 instead of 1000000011. The number of common trailing zeros is eight. The common leading bits of the second leaf node is 1 instead of 1101. The number of common trailing zeros is eight. The reason for this is as follows: assuming that we are searching endpoint 10011111 11111111 11111111 00000000, this endpoint is greater than the endpoint 10000110 11101111 00001101 10000000 and less than the first endpoint in the second group. If 1101 is taken as the leading bits of the second group, (i.e. four bits are skipped), 10011111 11111111 11111111 00000000 would mistakenly be taken as greater than the last endpoint in the second group.

After constructing the leaf nodes, we proceed to the next level using the same method. The number of endpoints in this level are reduced to approximately N/k, where N is the number of endpoints in the leaf level and k is the average number of endpoints in a leaf node. For k>4, it quickly converges to the root.

The second variant is slightly different as new end points are created.

Variant Two:

The essential difference between the variant one and the variant two is that a new endpoint is created to store in the higher level node rather than an existing endpoint.

The method for creating new endpoints for the high levels is first explained. Let {e₁, e₂, e₃, . . . , eₙ} be the set of endpoints to be stored in a tree structure. Assume the first four endpoints {e₁, e₂, e₃, e₄} are stored in the first leaf node and the next five endpoints {e₅, e₆, e₇, e₈, e₉} are stored in the second leaf node and the next four endpoints {e₁₀, e₁₁, e₁₂, e₁₃} are stored in the third leaf node and so on. The first endpoint to be stored in the higher level node is simply the common leading bits of {e₁, e₂, e₃, e₄} padded with trailing zeros to form a 32 bits endpoint \overline{e}₁. This new endpoint will be stored in the higher level node. The second endpoint is created according to e₄, e₅ and the number of common leading bits of {e₅, e₆, e₇, e₈, e₉}. Let n₁ be the number of common leading bits of e₄ and e₅; Let n₂ be the number of common leading bits of {e₅, e₆, e₇, e₈, e₉}. Let n₃=max{n₁+1, n₂}. Truncate the n₃ most significant bits of e₅ and padded with trailing zeros to form a 32 bits endpoint \overline{e}₂. This procedure continues for all the leaf nodes left. When the endpoints for the higher level nodes are created, we can use the procedure recursively to create the tree structure.

With this scheme, the search procedure needs to be modified. For searching an endpoint e₀ in the node, the number of skip bits in the data structure is used to truncate the most significant bits of e₀ to form a search key k₀ which is padded with trailing zeros. The biggest key kᵢ in the node which is less than or equal to k₀ is found. This leads us to search in the next lower level node (root node) in subtree tᵢ. If k₀=kᵢ a search of the keys in the root node of this subtree is needed as usual; If k₀>kᵢ, the endpoint e₀ is bigger than all the keys in this root node, thus a search is not needed.

The first variant above uses less memory storage space than the second variant but the second variant tends to use less memory accesses. From experimental results, it has been found that variant two is more useful for IP address tables dominated by long prefixes such as 32 bit long IPv4 addresses (after compression) or 128 bit long IPv6 addresses (again after compression). However, for an IP table dominated by short prefixes, the first variant is more useful.

A third variant is also possible by combining the first and second variants. For such a third option, variant one may be used in the early stages of creating the tree data structure and variant two may be used when the internal nodes close to the root node are being populated. Thus, variant one may be used for creating the leaf nodes and variant two may be used for all the other internal nodes.

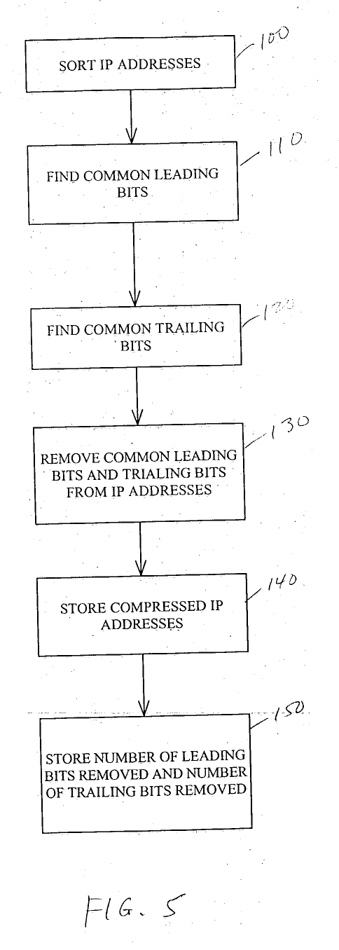

The variants above may be reduced into a number of steps illustrated in the flowchart of FIG. 5. The first step 100 is to sort the binary IP addresses (endpoints) by value order. Once the binary IP addresses are sorted, the common leading bits for the binary IP addresses are found (step 110). Next, the common trailing zeros are found for the binary IP addresses (step 120). Once both these pieces of information have been found, the common leading bits and the common trailing zeros can be stripped or removed from the IP addresses (step 130). The compressed IP addresses can then be stored (step 140) along with the number of leading bits removed and the number of trailing zeros removed (step 150).

FIG. 6 illustrates a block diagram of a sample hardware setup which may use the invention. As can be seen in FIG. 6, the chip die 200 includes an on-chip SRAM 210 and an ALU (arithmetic logic unit) 220. The port information is stored in a separate SRAM 230 located off-die. The on-chip SRAM 210 preferably has a 1 Mbit capacity with a 144 bit wide rows and less than 2¹³ columns. The ALU 220 receives a destination address and compares this destination address with the compressed addresses stored in the on-chip SRAM 210. Based on the comparison, the ALU 220 sends a pointer index to the on-chip SRAM 210 and receives, in return, data regarding the port to which the destination address relates. The next hop for the destination address is then provided by the ALU 220 to the off-die SRAM 230. The off-die SRAM 230 then provides the actual port for the next hop to the destination address.

As noted above, other hardware configurations and setups other than the one described above may be used to implement the invention.

Embodiments of the invention may be implemented in any conventional computer programming language. For example, preferred embodiments may be implemented in a procedural programming language (e.g. “C”) or an object oriented language (e.g. “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

A person understanding this invention may now conceive of alternative structures and embodiments or variations of the above all of which are intended to fall within the scope of the invention as defined in the claims that follow.

1. A method for storing a plurality of binary numbers such that said binary numbers can be searched for match between a candidate binary number and one of said plurality of binary numbers, the method comprising:
a) sorting said plurality of binary numbers in order of numerical value;
b) grouping said plurality of binary numbers into subgroups, each binary number in a subgroup having at least one leading bit in common with other binary numbers in said subgroup;
c) for each of said subgroups, determining a number x of leading bits common to members of said subgroup;
d) for each subgroup, recording said number x of leading bits;
f) for each subgroup, creating stripped binary numbers by removing x leading bits from members of said subgroup; and
g) storing each of said stripped binary numbers for each subgroup in a node data structure in a tree data structure, said node also containing information regarding said common leading bits for said subgroup.

2. A method according to claim 1 wherein said node structure further includes data indicating a number of members in a subgroup stored in said leaf structure.

3. A method according to claim 1 wherein said tree data structure includes a plurality of hierarchal levels, each level containing at least one node data structure, a level a containing at most an equal number of node data structures than level b where a<b.

4. A method according to claim 3 wherein for at least one of said plurality of levels, each node data structure contained in said at least one of said plurality of levels contains a pointer to a node data structure contained in another level.

5. A method according to claim 3 wherein binary number stored in a node data structure in level a₁ are used to determine said number x for a subgroup stored in a level b₁ wherein a₁<b₁.

6. A method according to claim 3 wherein a new binary number is created using binary numbers in a subgroup stored in a level b₂, said new binary number being stored in a node data structure contained in a level a₂, wherein a₂<b₂.

7. A method according to claim 3 wherein a new binary number is created using binary numbers from different subgroups stored in a level b₃, said new binary number being stored in a node data structure being contained in a level a₃, wherein a₃<b₃.

8. A method of storing IP binary addresses in a tree data structure for use in a range search, the method comprising:
a) sorting a group of IP binary addresses in order of numerical value;
b) determining a number of sequential bits common to said group of IP binary addresses, said sequential bits being chosen from a group comprising:
leading bits
trailing bits.
c) removing said sequential bits common to said group of IP binary addresses from said IP binary addresses; and
d) storing said group in a node in said tree data structure.

9. A method according to claim 8 wherein said node also stores how many sequential bits were removed from said IP binary addresses.

10. A method according to claim 8 wherein said tree data structure has multiple levels with each level having at least one node.

11. A method according to claim 10 wherein said at least one element in a node in a level a₁ is derived from contents of at least one node in a level b₁ where a₁<b₁.

12. A method according to claim 10 wherein said group is stored in a node in a level b₂ and said number of sequential bits common to said group is determined using at least one IP binary address stored in a node in a level a₂, wherein a₂<b₂.

13. A method according to claim 10 wherein at least one element in a node in a level a₃ is derived from sequential bits removed from IP binary addresses stored in a node in a level b₃, where a₃<b₃.

14. A method according to claim 13 wherein said at least one element is created from common leading bits removed from said IP binary addresses.

15. A method according to claim 10 wherein said at least one element in a node in level a₃ is derived from common leading bits of IP binary addresses stored in different nodes in a level b₃, wherein a₃<b₃.

16. A method according to claim 1 further including the step of, for each of subgroup, determining a number y of trailing bits common to members of said subgroup.

17. A method according to claim 16 wherein for step f), said stripped binary numbers are created by removing x leading bits and y trailing bits from members of said subgroup.

18. A method according to claim 16 further including the step of recording said number y of common trailing bits for each subgroup.

19. A method according to claim 17 wherein said node also contains information regarding said trailing bits for said subgroup.
